(19) United States
(12) Patent Application Publication
(10) Pub. No.: US 2017/0102840 A1
(43) Pub. Date: Apr. 13, 2017

(54) APPARATUS AND METHOD FOR A CONSOLIDATED WEB USER INTERFACE TO THE WORLD-WIDE-WEB

(71) Applicant: Tara Chand Singhal, Torrance, CA (US)

(72) Inventor: Tara Chand Singhal, Torrance, CA (US)

(21) Appl. No.: 15/288,213

(22) Filed: Oct. 7, 2016

Related U.S. Application Data
(60) Provisional application No. 62/238,646, filed on Oct. 7, 2015.

(51) Int. Cl. G06F 3/0482; H04L 29/06; G06F 3/0481; H04L 29/08

(52) U.S. Cl. CPC G06F 3/0482; H04L 67/02; H04L 67/38; G06F 3/04817

(57) ABSTRACT

An apparatus and method for a Web User Interface that facilitates an intuitive, improved, better organized and faster user interface to world wide web without first going to someone else's home page such as Google, Yahoo and ATT is described.

### CROSS REFERENCE

This application claims priority from U.S. Provisional Application Ser. No. 62/238,646, Titled “Apparatus and Method for a Web User Interface to the World-Wide-Web” Filed On Oct. 7, 2015, By Tara Chand Singhal. Application Ser. No. US 62/238,646 is incorporated in its entirety herein by this reference.

### FIELD OF THE INVENTION

Apparatus and method for an improved user interface for accessing websites on a global computer network are described.

### BACKGROUND

When accessing a website on world-wide-web, a typical user notionally 80% of the time may know where he or she needs to go on the www based on prior search history and a pre-identified favorite list of links and 20% of the time user may not know and needs a search engine for searching for a web page of interest.

The current web user interface to world-wide-web (www) requires a user to go to someone else's home page such as Google, Yahoo and ATT. These home pages of these businesses' may not be relevant for what the user wants, and loading of these home web pages, takes an uncertain and long time to load because of (i) many inherent latencies in loading a web page from the servers to the client and (ii) embedded in the web page, display of multiple and unwanted ads that are fetched from ad servers.

As a simplified illustration, if a user directly wants to go to Macy's website, the user need to first go to Google or Yahoo home page before the user can reach Macy's home page either via the favorite list of links or via the URL search bar.

Therefore, user interface to world-wide-web (www), for people using a web browser and a home page of a search engine company, is not optimum due to many issues such as time latencies inherent in this user interface approach. There are different types of time latencies on displaying a web page and its contents, such as: software in the device—browser—for rendering a display; requesting communication link—internet congestion;—server response time—server capacity; return communication link—internet congestion; loading of different ad content—from different ad servers.

Hence, it is the objective of the embodiments herein to provide for an improved and efficient Web User Interface in client computers that is an intuitive, improved, better organized and faster user interface, by eliminating these time latencies, to world wide web that are inherent in first going to someone else's home page such as Google, Yahoo and ATT.

Hence a direct web user interface provides the fastest and shortest path to the web page of interest to a user and avoids time latencies inherent in going to someone else's home page first.

### SUMMARY

An apparatus and method for a Consolidated Web User Interface (Web UI) that facilitates an intuitive, improved, better organized and faster consolidated and a single point user interface to world wide web without first going to someone else's home page such as Google, Yahoo and ATT is described.

Hence a single point direct web user interface, such as Consolidated Web UI described in this disclosure, provides the fastest and shortest path to the web page of interest to a user on world-wide-web and avoids time latencies inherent in going to someone else's home page first.

Consolidated Web UI facilitates an intuitive, improved, better organized, and faster user interface to world wide web without first going to someone else's home page such as Google, Yahoo and ATT; as these home pages of these businesses' may not be relevant for what the user wants, and loading of these home web pages of others, take a long and uncertain time to load because of (i) inherent latencies in loading a web page from the servers to the client and (ii) embedded display of multiple and unwanted ads.

There are different types of time latencies on displaying a web page and its contents, such as: software in the device—browser—for rendering a display; requesting communication link—internet congestion;—server response time—server capacity; return communication link—internet congestion; loading of different ad content—from different ad servers.

As a simplified illustration, if a user directly wants to go to Macy's website, the user need not first go to Google or Yahoo home page and can reach Macy's home page directly from the Web UI.

In prior art, a user can also create multiple web-link icons on the desk top for accessing web pages, however, these are cumbersome to create and use and do not provide a consolidated single point interface to the world-wide-web.

Hence a direct single point web user interface of a Consolidated Web UI as described herein, provides a more versatile that is the fastest and shortest path to the web page of interest to a user and avoids many time latencies as have been described above, that are inherent in going to someone else's home page first.

This is a value proposition that would appeal to many users who access world-wide-web for various reasons. These and other aspects of the embodiments herein are described and would become more clear with the help of the accompanying drawings and the accompanying description.

### BRIEF DESCRIPTION OF THE DRAWINGS

Some of the novel features of this invention will be best understood from the accompanying drawings, taken in conjunction with the accompanying description, in which similar reference characters refer to similar parts, and in which:

FIG. 1 is a block diagram that illustrates features of the present embodiments of the invention of a web user Interface;

FIG. 2 is a block diagram that illustrates features of the present embodiment of the invention for a web user interface;

FIG. 3 is a block diagram that illustrates logic features of the present embodiment of the invention for a web user interface;

FIG. 4A is a block diagram that illustrates features of the present embodiment of the invention for a web user interface on a laptop computer;

FIGS. 4B, 4C are block diagrams that illustrates features of the present embodiment of the invention for a web user interface for use in a smart phone; and

FIGS. 5A & 5B are method diagrams that illustrate features of the present embodiments of the invention of a web user interface.

### DESCRIPTION

### Introduction

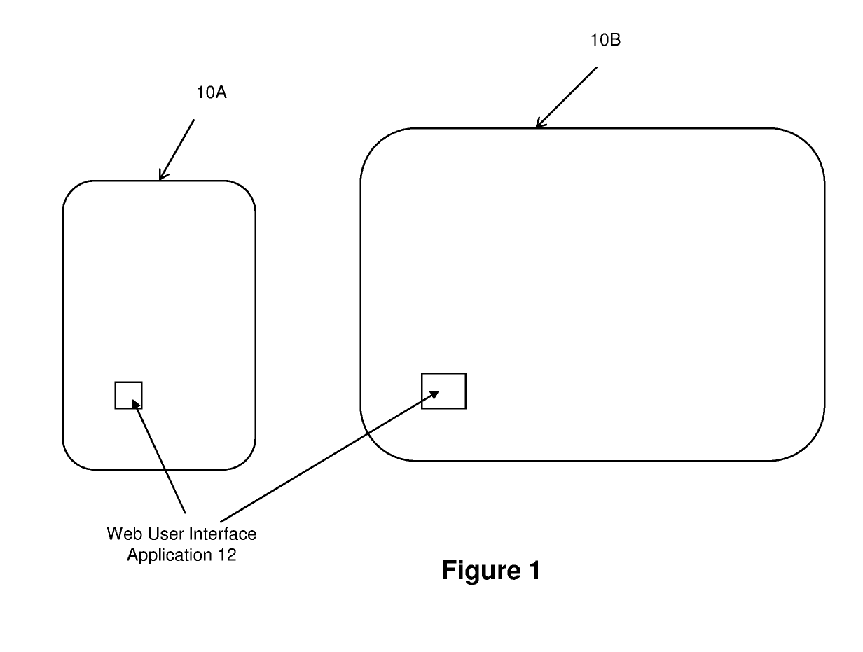

With reference to FIG. 1, in a preferred embodiment, a portable wireless computing device such as for illustration, a smart phone 10A, a laptop computer or a tablet computer 10B has a CPU, an operating system, a storage memory and a touch screen display (not shown).

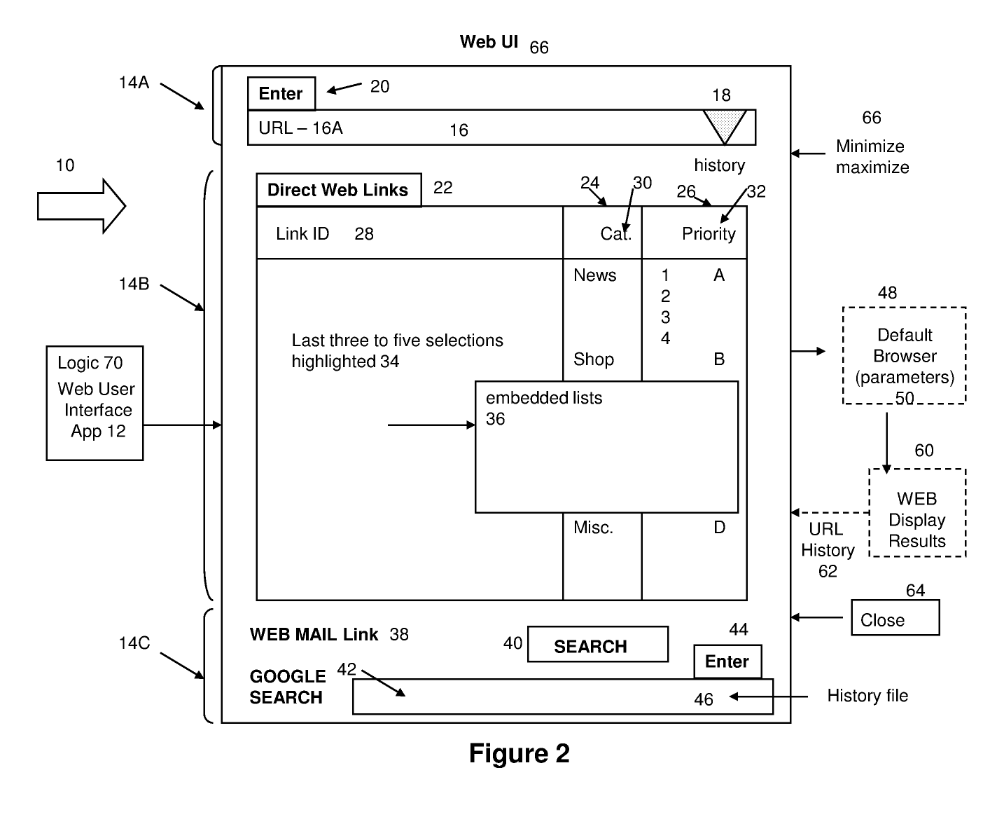

Therein, in the computing device 10A or 10B is hosted a system 10 for web user interface (Web UI) application logic 12. The web user interface, Web UI logic 12, when activated, displays a web user interface Web UI display 66 as in FIG. 2.

With reference to FIG. 2, the Web UI display 66 has three different display parts identified as display part 14A on the top of the display 66, display part 14B in the middle of display 66 and display part 14C at the bottom of display 66.

Each of these three display parts, 14A, 14B and 14C, may be minimized or maximized depending on a user preference and mode of use and may be displayed in a different sequence or order than those illustrated here with reference to FIG. 2.

Web UI display part 14A on the top part of the Web UI display 66, displays a window space 16 for entry of a URL 16A, has a drop down icon and feature 18 to drop down and display prior URL lists and an Enter button 20 to activate the selected URL 16A.

Web UI display part 14B, in the middle part of the Web UI display 66, displays a list of direct web links 22 by their URL or Link Ids 28. The list of direct web links 22 is arranged preferably in a three column format, where a first column is a list of direct web links 28, the second column 24 identifies a category 30 for each of these links in the categories of such as, news, shopping, travel etc. as a simplified example. The third column 26 identifies a priority 32 of display of these links in display part 14B. There are two different types of priorities. The first priority is a display sequence number within a category such as news, shopping etc., and the links alternatively may be displayed in an alphabetical order. The second priority is the display priority for the different categories as is listed as priority A, B, and C.

Both of these priorities are user settable to enable a user to organize the display of display part 14B that would best suit his/her preference. The display part 14B may also have embedded lists 36, when the number of link items may not fit the limited screen size. Further, the last three to five link prior selections may be highlighted 34 to enable a user to quickly navigate to the desired direct web link.

The third display part 14C at the bottom of the Web UI display 66, of the Web UI 12 has a search field 42 for entry of a search term for use with a prior art search engine such as Google. The display part 14C would also display a one or more Webmail link 38 and a link 40 to a pre-identified search engine other than Google. The search field 42 also displays a drop down of prior search history 46, to quickly select a search term without having to type it again.

Any of these display parts 14A, 14B, or 14C of the Web UI display 66 may be individually minimized and maximized and the entire Web UI display 66 may also be minimized and maximized.

When a web link is selected and activated, either from display part 14A, or display part 14B or display part 14C, a default browser application 48 is launched with the input parameters of the link URL and displays the fetched website results 60. The URL history 62 of these web displays is kept for use in history feature 18 of the display part 14A.

When a user has stopped making direct web links, the web browser 48 may be closed 64 allowing the user to display Web UI 66 and allow for a new or different direct web link selection from any of the display parts 14A, 14B or 14C of the Web UI display 66.

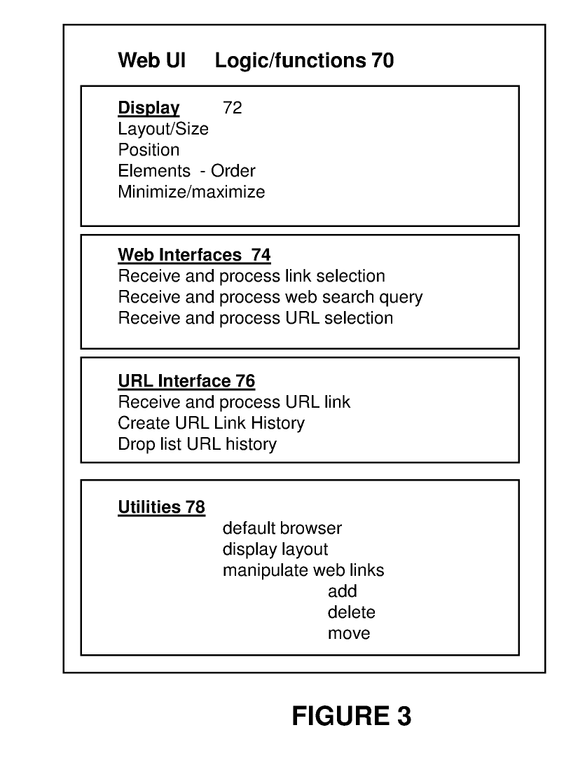

FIG. 3, illustrates Web UI logic 70. The logic 70 has logic parts of, display logic 72, Web Interface logic 74, a URL interface logic 76 and Utilities logic 78. Each of these logics has sub-logics to perform functions as has been identified in FIG. 3.

The display logic 72 renders on a display screen of a client, a display of Web UI display 66 with its three different display parts of 14A, 14B and 14C. Each display part 14A, 14B and 14C is structured on the client display screen as has been illustrated with the help of FIG. 2. There may other structures other than those illustrated with the help of FIG. 2 and these are not ruled out.

The logic 72 also performs the logics of functions that are embedded in each of these display parts 14A, 14B and 14C, as has been described earlier. These functions are drop down lists with history in display part 14A; organization and management of the web links and the corresponding structures as has been described earlier for display part 14B; web links, drop down lists and histories of the links as in display part 14C.

The Web Interface logic 74 performs functions of receiving and processing link selections from display parts 14A, 14B and 14C; receiving and processing web search queries from display part 14C and receiving and processing URL selections from display part 14A; processing interfaces of the Web UI logic 72 with the pre-stored content in the client, and managing a pre-stored web browser application.

The URL Interface logic 76 manages URL links, that are newly created and the history of prior URL links using prior art structures of drop down lists.

The Utilities logic 78 provides utilities that are used for different purpose in the various logics described above, for example in adding, deleting and moving web links in display part 14B, managing display layout of Web UI display 66, and maintaining one or more browser applications, providing a default browser and opening, closing the default browser.

The knowledge of software engineering and computer science to code and implement these specific features as has been described in the various logic is considered prior art, except the specific logic features as described herein.

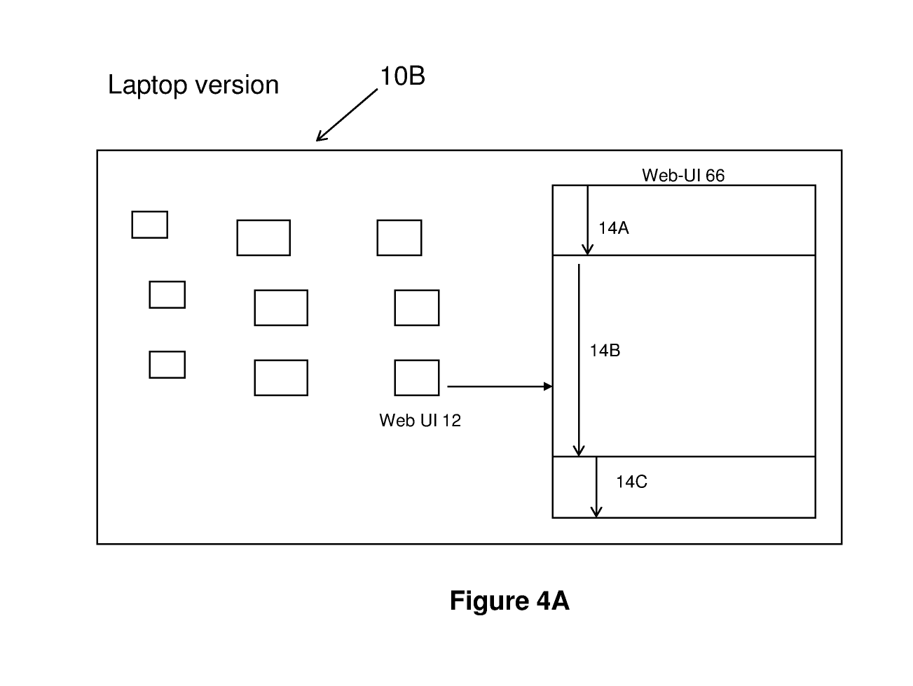

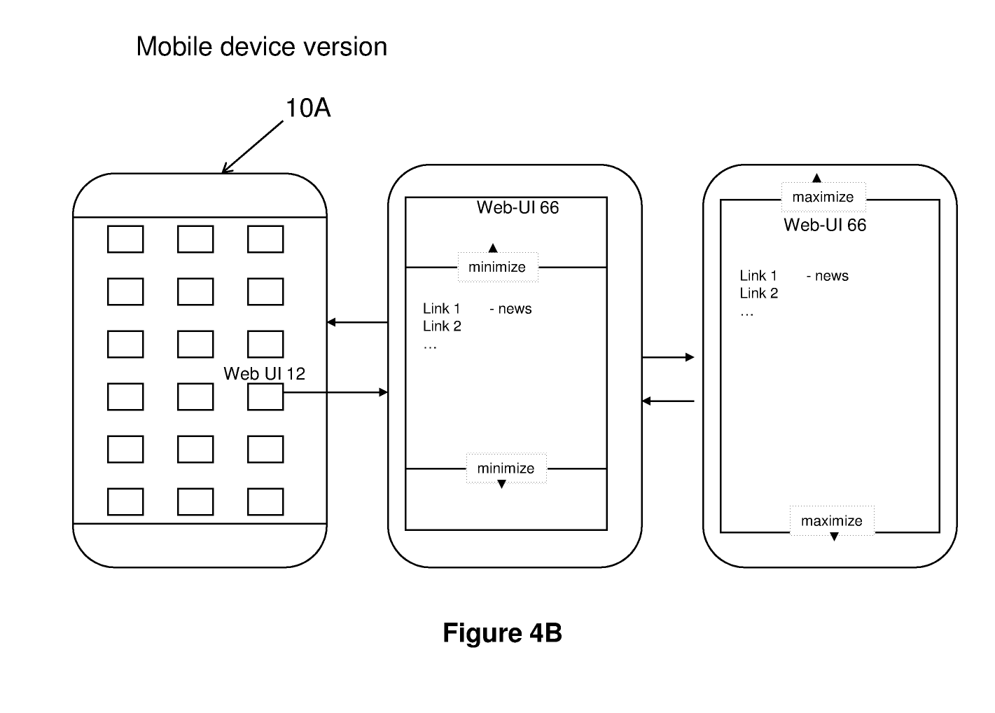

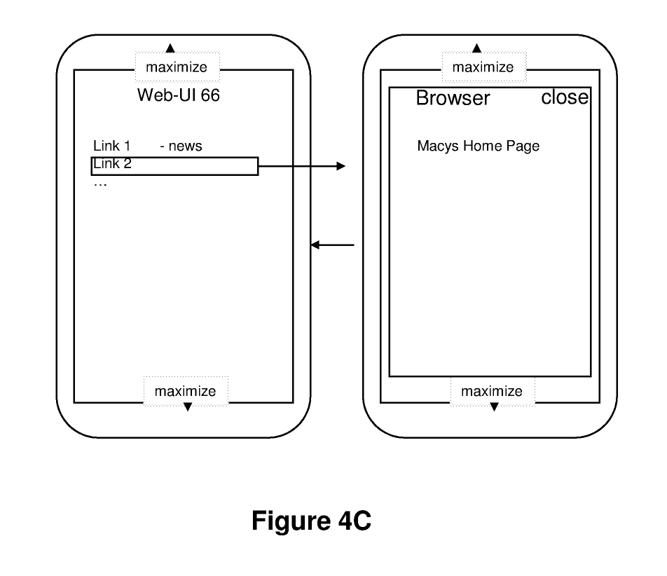

The Web UI 12 may be used hosted or implemented in either a laptop or a handheld device such as a smart phone. FIG. 4A illustrates uses of Web UI 12 on a laptop. As illustrated, when the Web UI 12 on the laptop is activated, a Web UI 66 is displayed on a part of the display screen of the laptop.

FIGS. 4B and 4C illustrate use of Web UI 12 on a smart phone. FIG. 4B illustrates that when the Web UI 12 application is launched, the Web UI 66 with its three display parts, 14A, 14B, and 14C is displayed. Each part may be separately minimized and maximized for a user to effectively use the limited size of the display screen based on his/her objectives.

FIG. 4C illustrates that when a direct link such as for Macys is selected from part 14B, Macy's website is displayed.

Therefore the Web UI 12 of this invention enables direct link to a web without first going to someone else's website and provides a better and more intuitive arrangement of the direct web links, in Web UI display 66.

The Web UI links in Web UI 66 may be directed to world-wide-web or may be directed to digital content stored in the device itself. The digital content stored in the device memory that follows the standard identification and nomenclature protocol of Uniform Resource Locator (URL) protocol of the web may also be used to store and access digital content in the device itself.

These two different types of URL links, one for on the web and the other in the device itself may be highlighted to identify the type of link for use in the Web UI 66 display. Alternatively, a separate UI may be used for internal to device content links.

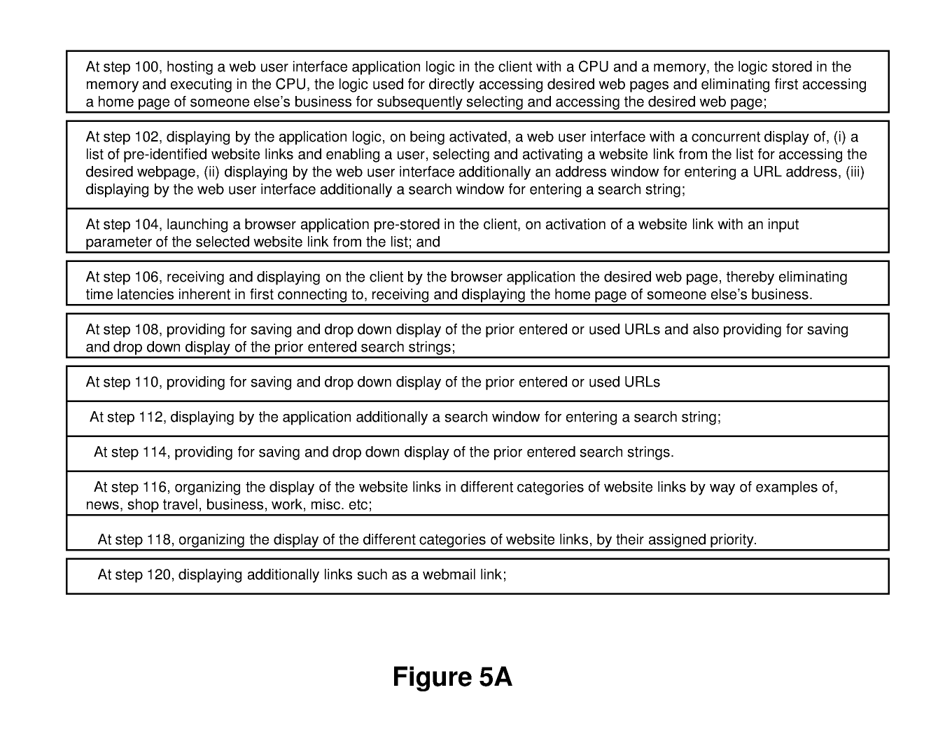

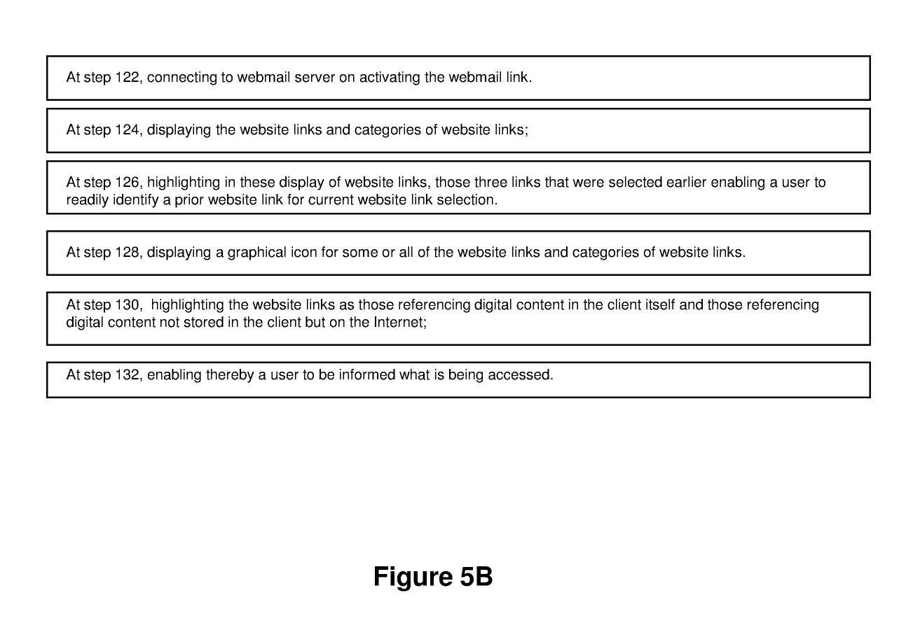

FIG. 5 illustrates a method diagram, where all the steps may not be used or used in the order specified.

At step 100, hosting a web user interface application logic in the client with a CPU and a memory, the logic stored in the memory and executing in the CPU, the logic used for directly accessing desired web pages and eliminating first accessing a home page of someone else's business for subsequently selecting and accessing the desired web page;

At step 102, displaying by the application logic, on being activated, a web user interface with a concurrent display of, (i) a list of pre-identified website links and enabling a user, selecting and activating a website link from the list for accessing the desired webpage, (ii) displaying by the web user interface additionally an address window for entering a URL address, (iii) displaying by the web user interface additionally a search window for entering a search string;

At step 104, launching a browser application pre-stored in the client, on activation of a website link with an input parameter of the selected website link from the list; and

At step 106, receiving and displaying on the client by the browser application the desired web page, thereby eliminating time latencies inherent in first connecting to, receiving and displaying the home page of someone else's business.

At step 108, providing for saving and drop down display of the prior entered or used URLs and also providing for saving and drop down display of the prior entered search strings;

At step 110, providing for saving and drop down display of the prior entered or used URLs;

At step 112, displaying by the application additionally a search window for entering a search string;

At step 114, providing for saving and drop down display of the prior entered search strings;

At step 116, organizing the display of the website links in different categories of website links by way of examples of, news, shop travel, business, work, misc. etc;

At step 118, organizing the display of the different categories of website links, by their assigned priority;

At step 120, displaying additionally links such as a webmail link;

At step 122, connecting to webmail server on activating the webmail link;

At step 124, displaying the website links and categories of website links;

At step 126, highlighting in these display of website links, those three links that were selected earlier enabling a user to readily identify a prior website link for current website link selection;

At step 128, displaying a graphical icon for some or all of the website links and categories of website links;

At step 130, highlighting the website links as those referencing digital content in the client itself and those referencing digital content not stored in the client but on the Internet;

At step 132, enabling thereby a user to be informed what is being accessed.

An apparatus for a consolidated user interface in a client for accessing a desired web page in a server on a world wide web using a global computer network has a client with a CPU and a memory and a browser application and a communication interface circuits, the client hosts a web user interface (Web UI) application on the client for directly accessing desired web pages that eliminates first accessing a home page of someone else's business for subsequently selecting and accessing the desired web page.

The Web UI application displays, on being activated, a list of website links that enable a user, selecting and activating a website link from the list for accessing the desired web pages. The Web UI launches the browser application with an input parameter of the selected website link from the list and the browser application receives and displays on the client the desired web page, thereby eliminating time latencies inherent in first connecting to, receiving and displaying the home page of someone else's business.

The Web UI application displays additionally an address window for entering URL address. The application saves and provided drop down display of the prior entered or used URLs.

The Web UI application additionally displays a search window for entering a search string. The application provides for saving and dropdown display of the prior entered search strings.

The Web UI application organizes the display of the website links in different categories of website links by way of examples of, news, shop travel, business, work, misc. etc. The application organizes the display of the different categories of website links by their assigned priority.

The application displays additionally links such as a webmail link and the application connects to webmail server on activating the webmail link.

The application displays the website links and categories of website links. The display highlights in these display of website links, those three links that were selected earlier enabling a user to readily identify a prior website link for current website link selection.

The application displays a graphical icon for some or all of the website links and categories of website links.

An apparatus for a consolidated user interface in a client for accessing a desired web page in a server on a world wide web using a global computer network has a client with a CPU and a memory and a browser application and a communication interface circuits, the client hosts a web user interface (Web UI) application on the client for directly accessing desired web pages that eliminates first accessing a home page of someone else's business for subsequently selecting and accessing the desired web page.

The application logic, on being activated, displays a web user interface with a concurrent display of, (i) a list of pre-identified website links and enabling a user, selecting and activating a website link from the list for accessing the desired webpage, (ii) displaying by the web user interface additionally an address window for entering a URL address, (iii) displaying by the web user interface additionally a search window for entering a search string.

The browser application receives and displays on the client the desired web page, thereby eliminating time latencies inherent in first connecting to, receiving and displaying the home page of someone else's business.

The application launches a browser application pre-stored in the client, on activation of a website link with an input parameter of the selected website link from the list; and the application receives and displays on the client by the browser application the desired web page, thereby eliminating time latencies inherent in first connecting to, receiving and displaying the home page of someone else's business.

The application provides for saving and drop down display of the prior entered or used URLs and also providing for saving and drop down display of the prior entered search strings.

The Web UI application organizes the display of the website links in different categories of website links by way of examples of, news, shop travel, business, work, misc. etc and the application organizes the display of the different categories of website links by their assigned priority.

The application displays additionally links such as a webmail link and the application connects to webmail server on activating the webmail link.

The application displays the website links and categories of website links; the display highlights in these display of website links, those three links that were selected earlier enabling a user to readily identify a prior website link for current website link selection. The application displays a graphical icon for some or all of the website links and categories of website links.

A method for a user interface in a client, comprising the steps of, where all the steps may not be used or used in the order specified:

displaying a web user interface on a display screen of a client, with a concurrent display of three display parts, wherein each display part directed to displaying a different user interface that are applicable to different types of interfaces;

pre-identifying a first display part for website links enabling a user, selecting and activating a website link from the list for accessing the desired webpage;

displaying a second display part by the web user interface for an address window for entering a URL address;

displaying a third display part by the web user interface for a search window for entering a search string; and wherein each display part is individually minimized and maximized for display.

In summary, the embodiments herein are on systems and methods for a Web User Interface that facilitates an intuitive, improved, better organized and faster user interface to world wide web without first going to someone else's home page such as Google, Yahoo and ATT is described.

While the particular embodiments, as illustrated herein and disclosed in detail are fully capable of obtaining the objective and providing the advantages herein before stated, it is to be understood that it is merely illustrative of the presently preferred embodiments of the invention and that no limitations are intended to the details of construction or design herein shown other than as described in the appended claims.

1. A method for a consolidated user interface in a client for accessing a desired web page in a server on a world-wide-web using a global computer network comprising the steps of:
hosting a web user interface application logic in the client with a CPU and a memory, the logic stored in the memory and executing in the CPU, the logic used for directly accessing desired web pages without first accessing a home page of someone else's business for subsequently selecting and accessing the desired web page;
displaying by the application logic, on being activated, a web user interface with a concurrent display of one or more display parts, wherein (i) a first display part pre-identifies website links enabling a user, selecting and activating a website link from the list for accessing the desired webpage, (ii) a second display part for displaying by the web user interface additionally an address window for entering a URL address, (iii) a third display part for displaying by the web user interface additionally a search window for entering a search string.

2. The method as in claim 1, further comprising the steps of:
launching a browser application pre-stored in the client, on activation of a website link with an input parameter of the selected website link from the list; and
receiving and displaying on the client by the browser application the desired web page, thereby eliminating time latencies inherent in first connecting to, receiving and displaying the home page of someone else's business.

3. The method as in claim 1, further comprising the steps of:
providing for saving and drop down display of the prior entered or used URLs and also providing for saving and drop down display of the prior entered search strings.

4. The method as in claim 1, further comprising the steps of:
organizing the display of the website links in different categories of website links by way of examples of, news, shop travel, business, work, misc. etc;
organizing the display of the different categories of website links by their assigned priority.

5. The method as in claim 1, further comprising the steps of:
displaying additionally links such as a webmail link;
connecting to a webmail server on activating the webmail link.

6. The method as in claim 1, further comprising the steps of:
displaying the website links and categories of website links;
highlighting in these display of website links, those three to five links that were selected earlier enabling a user to readily identify a prior website link for current website link selection.

7. The method as in claim 1, further comprising the steps of:
displaying a graphical icon for some or all of the website links and categories of website links.

8. The method as in claim 1, further comprising the steps of:
highlighting the website links as those referencing digital content in the client itself and those referencing digital content not stored in the client but on the Internet, enabling thereby a user be informed what is being accessed.

9. An apparatus for a consolidated user interface in a client for accessing a desired web page in a server on a world wide web using a global computer network comprising:
a client with a CPU and a memory and a browser application and a communication interface circuits, the client hosts a web user interface (WEB_UI) application on the client for directly accessing desired web pages that eliminates first accessing a home page of someone else's business for subsequently selecting and accessing the desired web page;
the application logic, on being activated, displays a web user interface with a concurrent display of, (i) a list of pre-identified website links and enabling a user, selecting and activating a website link from the list for accessing the desired webpage, (ii) displaying by the web user interface additionally an address window for entering a URL address, (iii) displaying by the web user interface additionally a search window for entering a search string; and
the browser application receives and displays on the client the desired web page, thereby eliminating time latencies inherent in first connecting to, receiving and displaying the home page of someone else's business.

10. The apparatus as in claim 9, further comprising:
the application launches a browser application pre-stored in the client, on activation of a website link with an input parameter of the selected website link from the list; and
the application receives and displays on the client by the browser application the desired web page, thereby eliminating time latencies inherent in first connecting to, receiving and displaying the home page of someone else's business.

11. The apparatus as in claim 9, further comprising:
the application provides for saving and drop down display of the prior entered or used URLs and also providing for saving and drop down display of the prior entered search strings.

12. The apparatus as in claim 9, further comprising:
the WEB_UI application organizes the display of the website links in different categories of website links by way of examples of, news, shop travel, business, work, misc. etc;
the application organizes the display of the different categories of website links by their assigned priority.

13. The apparatus as in claim 9, further comprising:
the application displays additionally links such as a webmail link;
the application connects to webmail server on activating the webmail link.

14. The apparatus as in claim 9, further comprising:
the application displays the website links and categories of website links;
the display highlights in these display of website links, those three links that were selected earlier enabling a user to readily identify a prior website link for current website link selection.

15. The apparatus as in claim 9, further comprising:
the application displays a graphical icon for some or all of the website links and categories of website links.

16. A method for a user interface in a client, comprising the steps of:
displaying a web user interface on a display screen of a client, with a concurrent display of three display parts, wherein each display part directed to displaying a different user interface that are applicable to different types of interfaces.

17. The method for a user interface in a client, as in claim 16, further comprising the steps of:
pre-identifying a first display part for website links enabling a user, selecting and activating a website link from the list for accessing the desired webpage.

18. The method for a user interface in a client, as in claim 16, further comprising the steps of:
displaying a second display part by the web user interface for an address window for entering a URL address.

19. The method for a user interface in a client, as in claim 16, further comprising the steps of:
displaying a third display part by the web user interface for a search window for entering a search string.

20. The method for a user interface in a client, as in claim 16, further comprising the steps of:
displaying a web user interface on a display screen of a client, with a concurrent display of three display parts, wherein each display part directed to displaying a different user interface that are applicable to different types of interfaces, and wherein each display part is individually minimized and maximized for display.
